(19) United States
(12) Patent Application Publication
(10) Pub. No.: US 2025/0159637 A1
(43) Pub. Date: May 15, 2025

(54) DEVICE MANAGEMENT SYSTEM AND METHOD

(71) Applicant: Getac Technology Corporation, New Taipei City (TW)

(72) Inventor: Chi-Tsan Lin, Taipei City (TW)

(21) Appl. No.: 18/771,117

(22) Filed: Jul. 12, 2024

(30) Foreign Application Priority Data
Nov. 15, 2023 (TW) 112144087

(51) Int. Cl. H04W 60/00; H04W 12/04; H04W 48/08; H04W 84/18

(52) U.S. Cl. CPC H04W 60/00; H04W 12/04; H04W 48/08; H04W 84/18

(57) ABSTRACT

Disclosed are a device management system and a method thereof. The device management system comprises an entry server, a first server, a second server, and an electronic device bound with the first server. The device management method comprises: sending, by the entry server, a server-switching instruction corresponding to the electronic device to the first server, such that the first server sends a binding termination instruction to the electronic device; sending, by the electronic device, an address-requesting instruction corresponding to the second server to the entry server, such that the entry server sends an address of the second server to the electronic device; and sending, by the electronic device, a registration information instruction to the second server to execute binding, and exchanging data information with the second server. In this way, data only needs to be modified on the entry server, and the electronic device can automatically find the correct server.

### CROSS-REFERENCE TO RELATED PATENT APPLICATION

This application claims the benefit of priority to the Taiwan Patent Application No. 112144087, filed on Nov. 15, 2023. The entire content of the Taiwan Patent Application No. 112144087 is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE INVENTION

The present invention relates to a device management system and method, and in particular to a device management system and method concerning the switching of binding.

### BACKGROUND OF THE INVENTION

Internet of Things is a widely used technology for interconnection and information exchange. In a field of Internet of Things with specific binding relationships, both termination and switching of binding have to be done manually by operating personnel. Therefore, discovering a way to simplify the manual operating steps and to achieve automation has become an imperative for the technical field.

### SUMMARY OF THE INVENTION

The present invention provides a device management system and method that can simplify operation steps of terminating and switching binding and achieve automation.

The device management system provided by the present invention comprises: an entry server, a first server coupled to the entry server, a second server coupled to the entry server, and an electronic device bound with the first server. The device management method executed by the device management system comprises: sending, by the entry server, a server-switching instruction corresponding to the electronic device to the first server, such that the first server sends a binding termination instruction to the electronic device; sending, by the electronic device, an address-requesting instruction corresponding to the second server to the entry server, such that the entry server sends an address of the second server to the electronic device; and sending, by the electronic device, a registration information instruction to the second server to execute binding, and exchanging data information with the second server.

The device management method provided by the present invention is suitable for the device management system, wherein the device management system comprises an entry server, a first server, a second server, and an electronic device, and the electronic device and the first server are bound together. The device management method comprises: sending, by the entry server, a server-switching instruction corresponding to the electronic device to the first server, such that the first server sends a binding termination instruction to the electronic device; sending, by the electronic device, an address-requesting instruction corresponding to the second server to the entry server, such that the entry server sends an address of the second server to the electronic device; and sending, by the electronic device, a registration information instruction to the second server to execute binding, and exchanging data information with the second server.

In an embodiment of the present invention, the above first server and second server are Internet of Things servers, and the electronic device is an Internet of Things device.

In an embodiment of the present invention, the above device management method further comprises: verifying the binding termination instruction, by the electronic device using a public key of the first server, to determine whether to terminate binding.

In an embodiment of the present invention, the above-mentioned sub-step of sending, by an electronic device, a registration information instruction to a second server to execute binding comprises: receiving, by the electronic device, a registration-permitting instruction and a public key from the second server.

In an embodiment of the present invention, the above-mentioned sub-step of exchanging data information between the electronic device and the second server comprises: verifying the data information by the second server using the public key of the electronic device in the registration information instruction to determine whether to receive the data information.

With the adoption of the device management method provided by the present invention, the effects of simplifying steps of terminating and switching binding and realizing automation can be achieved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a device management system provided by embodiments of the present invention.

FIG. 2 is a flow chart of steps of a device management method provided by embodiments of the present invention.

FIG. 3 is a flow chart of a sub-step of sending, by an electronic device, a registration information instruction to a second server to execute binding, provided by embodiments of the present invention.

FIG. 4 is a flow chart of a sub-step of exchanging data information between the electronic device and the second server, provided by embodiments of the present invention.

### DETAILED DESCRIPTION OF PREFERRED EMBODIMENTS

To make the objectives, solutions and advantages of the present invention clearer, the present invention will be further described in detail below, with reference to appended drawings and embodiments. It should be understood that the specific embodiments described here are used only as an illustration of the present invention, rather than a limitation thereto. All other embodiments obtained by a person of ordinary skill in the art based on the embodiments of the present invention without creative efforts shall fall within the protection scope of the present invention.

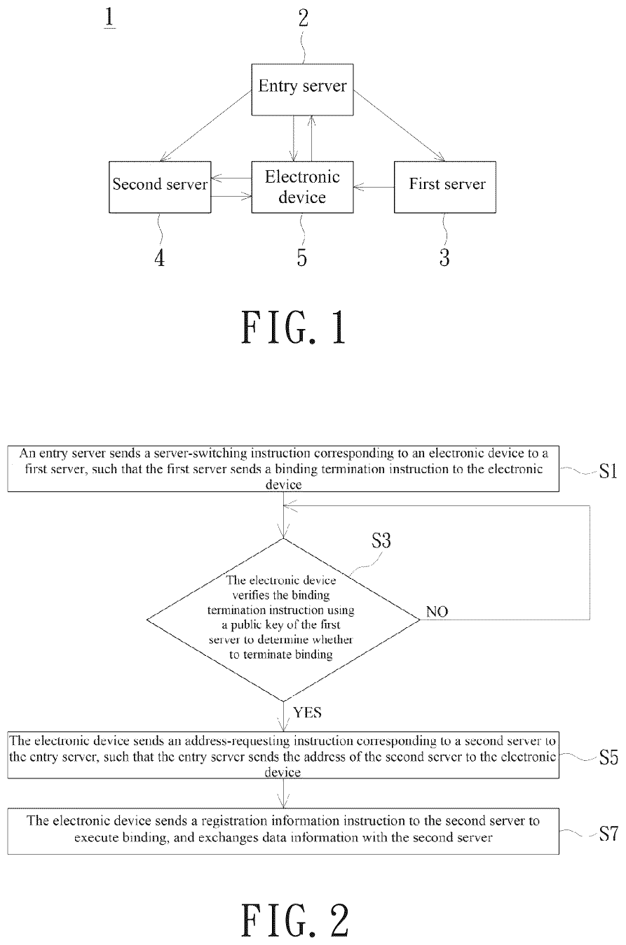

With reference to FIG. 1, it is a schematic diagram of a device management system provided by embodiments of the present invention. The device management system 1 provided by the embodiment comprises an entry server 2, at least one server, and an electronic device 5, wherein the at least one server comprises a first server 3 and a second server 4, and the at least one server is coupled to the entry server 2. Additionally, the first server 3 and the second server 4 are Internet of Things servers, and the electronic device is an Internet of Things device 5. It is to be understood that, in this embodiment, the electronic device 5 and the first server 3 are bound together to perform data information exchange, and then, through the device management method provided by the present invention, the binding between the electronic device 5 and the first server 3 is terminated, and the binding between the electronic device 5 and the second server 4 is registered, so as to allow data information exchange between the electronic device 5 and the second server 4.

With reference to FIG. 2, it is a flow chart of a device management method provided by embodiments of the present invention. The device management method provided by the embodiment, when executed by the device management system 1, comprises the following steps. Step S1: the entry server 2 sends a server-switching instruction corresponding to the electronic device 5 to the first server 3, such that the first server 3 sends a binding termination instruction to the electronic device 5. Specifically, each server has a plurality of bound electronic devices 5 with which each server performs data information exchange. However, in case of an incident, e.g. when the electronic device 5 no longer performs data information exchange with the original server after repair, but performs data information exchange with other servers, the binding between the electronic device 5 and the original server must be terminated before the electronic device can perform registration, binding, and data information exchange with a new server. Therefore, the server-switching instruction corresponding to the electronic device 5 is sent by the entry server 2 to make the original server terminate its binding with the electronic device 5, and make the original server send the binding termination instruction to the electronic device 5 to terminate its binding with the original server, which prevents the electronic device 5, when connected to the internet, from reconnecting to the original server and not being able to perform registration, binding, and data information exchange with the new server.

Step S3: the electronic device 5 verifies the binding termination instruction using a public key of the first server 3 to determine whether to terminate binding. Specifically, the electronic device 5 holds a public key of the original server, which is used for verification when the electronic device performs data information exchange with the original server. Similarly, when its binding with the original server is terminated, the electronic device 5 verifies the binding termination instruction using the public key of the original server. Therefore, when the verification using the public key is successful, the binding will be terminated.

Step S5: when the result is a YES, the electronic device 5 sends an address-requesting instruction corresponding to the second server 4 to the entry server 2, such that the entry server 2 sends an address of the second server 4 to the electronic device 5. Specifically, when its binding with the original server is terminated, the electronic device 5 will request an address of a new server from the entry server 2 before the electronic device and the new server are connected to the internet, so as to perform registration, binding, and data information exchange.

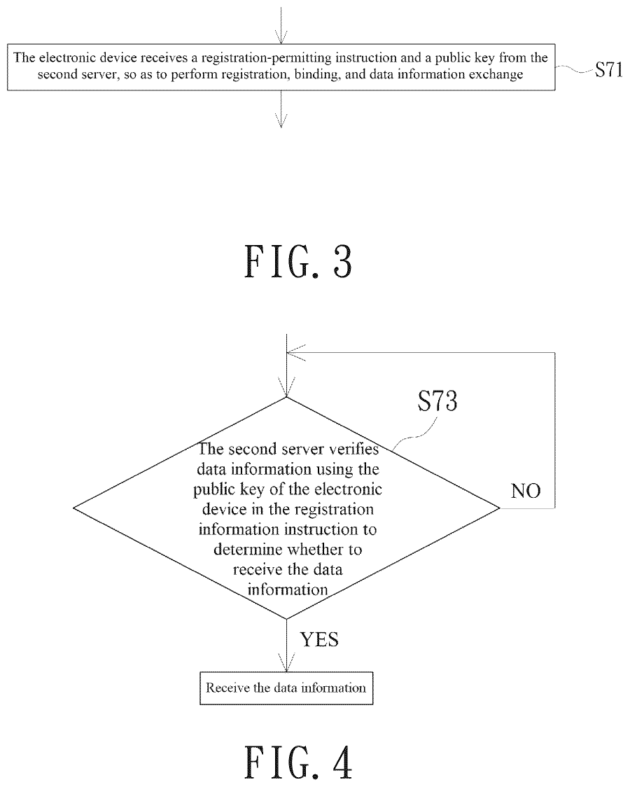

Step S7: the electronic device 5 sends a registration information instruction to the second server 4 to execute binding, and exchanges data information with the second server 4. With reference to FIG. 3, it is a flow chart of a sub-step of sending, by an electronic device, a registration information instruction to a second server to execute binding, provided by embodiments of the present invention. Specifically, when the new server receives the registration information instruction from the electronic device 5 and allows registration of the electronic device 5, Step S71 is executed: the electronic device 5 receives a registration-permitting instruction and a public key from the second server 4, so as to perform registration, binding, and data information exchange.

Then, with reference to FIG. 4, it is a flow chart of a sub-step of exchanging data information between the electronic device and the second server, provided by embodiments of the present invention. When the electronic device 5 performs data information exchange with the new server, Step S73 is executed: the second server 4 verifies the data information using the public key of the electronic device 5 in the registration information instruction to determine whether to receive the data information. Specifically, when the new server exchanges data information with the electronic device 5 after the electronic device 5 is successfully registered and bound with the new server, the data information from the electronic device 5 is verified by the public key of the electronic device 5.

As described above, with the adoption of the device management method provided herein, the effects of simplifying steps of terminating and switching binding and realizing automation can be achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device management system, comprising:
an entry server;
a first server, coupled to the entry server;
a second server, coupled to the entry server; and
an electronic device, bound with the first server;
wherein the device management system executes a device management method, and the device management method comprises:
sending, by the entry server, a server-switching instruction corresponding to the electronic device to the first server, so that the first server sends a binding termination instruction to the electronic device;
sending, by the electronic device, an address-requesting instruction corresponding to the electronic device to the entry server, so that the entry server sends an address of the second server to the electronic device; and
sending, by the electronic device, a registration information instruction to the second server to execute binding, and exchanging data information with the second server.

2. The device management system according to claim 1, wherein the first server and the second server are Internet of Things servers, and the electronic device is an Internet of Things device.

3. The device management system according to claim 1, wherein the device management method further comprises:
verifying the binding termination instruction by the electronic device using a public key of the first server to determine whether to terminate binding.

4. The device management system according to claim 1, wherein the sending, by the electronic device, the registration information instruction to the second server to execute binding comprises:
receiving, by the electronic device, a registration-permitting instruction and a public key from the second server.

5. The device management system according to claim 4, wherein the exchanging of the data information between the electronic device and the second server comprises:
verifying the data information by the second server using the public key of the electronic device in the registration information instruction to determine whether to receive the data information.

6. A device management method suitable for a device management system, wherein the device management system comprises an entry server, a first server, a second server, and an electronic device, the electronic device and the first server are bound together, and the device management method comprises:
sending, by the entry server, a server-switching instruction corresponding to the electronic device to the first server, so that the first server sends a binding termination instruction to the electronic device;
sending, by the electronic device, an address-requesting instruction corresponding to the electronic device to the entry server, so that the entry server sends an address of the second server to the electronic device; and
sending, by the electronic device, a registration information instruction to the second server to execute binding, and exchanging data information with the second server.

7. The device management method according to claim 6, wherein the first server and the second server are Internet of Things servers, and the electronic device is an Internet of Things device.

8. The device management method according to claim 6, wherein the device management method further comprises:
verifying the binding termination instruction by the electronic device using a public key of the first server to determine whether to terminate binding.

9. The device management method according to claim 6, wherein the sending, by the electronic device, the registration information instruction to the second server to execute binding comprises:
receiving, by the electronic device, a registration-permitting instruction and a public key from the second server.

10. The device management method according to claim 9, wherein the exchanging of the data information between the electronic device and the second server comprises:
verifying the data information by the second server using the public key of the electronic device in the registration information instruction to determine whether to receive the data information.
